(19) United States
(12) Patent Application Publication
(10) Pub. No.: US 2021/0367481 A1
(43) Pub. Date: Nov. 25, 2021

(54) COMPACT RANKINE TURBOGENERATOR DEVICE FOR DISTRIBUTED CO-GENERATION OF HEAT AND ELECTRICITY

(71) Applicant: Smart E, LLC, Dover, DE (US)

(72) Inventors: Esteban José Echenique, Buenos Aires (AR); Santiago Labollita, Ciudad Autonoma De Buenos Aires (AR)

(21) Appl. No.: 16/978,107

(22) PCT Filed: Jun. 7, 2019
(86) PCT No.: PCT/US2019/036156

§ 371 Date: Sep. 3, 2020

Related U.S. Application Data
(60) Provisional application No. 62/683,386, filed on Jun. 11, 2018.

(51) Int. Cl. H02K 7/18; H02K 9/19; H02K 7/09; F01D 15/10

(52) U.S. Cl. CPC H02K 7/1823; H02K 9/19; F05D 2220/76; F01D 15/10; F05D 2220/32; H02K 7/09

(57) ABSTRACT

A compact heat and electricity co-generation device comprised by: a) a heat generating system connected to a steam generator, a condenser and an internal working fluid, wherein said steam is obtained by external combustion of a suitable fuel in a boiler and/or by conduction of external hot gases to a boiler; y b) an electricity generator system comprised by: i) one or more radial and/or axial turbines; ii) an electric axial flow generator; and iii) an electronic control inverter. The fuel can be a solid, liquid or gaseous fuel. Both the turbine and the electric generator have passive magnetic bearings and electrodynamic bearings. The equipment does not use mechanical seals as all moving parts are housed within working fluid the pressure containment of the working fluid.

### FIELD OF THE INVENTION

The present invention relates to the field of electrical and thermal generation equipment. Specifically, the present invention relates to devices or small equipment to co-generate electricity and heat.

### BACKGROUND ART

Distributed generation equipment are low power electric generation systems (below 1,000 kW) that can supplement part of the power consumption of a user facility (without affecting the network) or inject power in the network without requiring modifications on it.

Co-generation systems are devices or fixed installations that use the residual heat of a power generation equipment to completely or partially supply the heat requirement of users. Conversely, there are co-generation systems that use the residual heat of a thermal process (furnaces, boilers, etc.) to generate electricity.

This invention is capable of functioning in any of the two schemes, that is, producing heat on its own or using external residual heat. In both cases, the device generates electricity that partially or totally supplements the user power consumption and significantly reduces the total fuel requirement by supplying thermal and electrical energy jointly instead of separately.

The way to achieve this is based on the implementation of a Rankine type thermal cycle (liquid-vapor) that drives a high speed microturbine that drives a permanent magnet generator. Electric power is supplied to the local network (user facilities) by electronic inverters.

There are numerous technical alternatives to achieve the co-generation of heat and electricity. The thermal machine can be based on various cycles such as Bryton, Otto, Diesel and Stirling. The electric generator can be synchronous with the network or power an electronic inverter. There may be a direct coupling between the thermal machine and the generator or there may be an intermediate fixed or variable reduction box. There are even systems based on fuel cells, in which case the thermal machine and the electric generator are the same device.

The existing co-generation systems in the art face the following technical problems that the device of this application intends to overcome:

a) Machines based on the Otto and Diesel cycle (piston engines) are extremely sensitive to the type and quality of fuel they use. These must have well controlled characteristics such as octane number, viscosity, impurity content, humidity, etc. Additionally, due to the internal mechanism they use, their components are subject to great friction efforts. Therefore, they require complex lubrication systems and regular and rigorous preventive maintenance.

b) Machines that use the Bryton cycle (gas turbine) partially or totally eliminate the need for lubrication since they are comprised by a significantly smaller number of moving parts. Their main problem is the sensitivity to the quality of the fuel. When using internal combustion, the impurities present in the fuel can cause severe problems of post-combustion corrosion in the most thermally and mechanically required components.

c) Stirling type machines (double piston systems) solve the sensitivity to fuel by using external combustion chambers. They do not solve the problem of lubrication as they use pistons. The main problem with Stirling machines is the large size they require to produce similar power as the previous systems.

The document published as U.S. Pat. No. 6,234,400 refers to a device for co-generation of heat and electricity for buildings and homes, wherein the condenser of the thermal cycle is an air cooler and/or a hot water accumulator tank for heating. It uses a radial flow electric generator externally coupled to a low speed spiral type expander. It does not specify the type of bearings or lubricant used, which appear to be conventional.

The document published as US 2006/220388 refers to a combined Bryton/Rankine turbo-group wherein the turbines and the compressor are mounted on the same shaft as the permanent magnet and radial flow electric generator. The assembly is housed inside the same housing and supported by conventional bearings. The working fluid of the Rankine turbine is isolated from the rest by conventional mechanical seals.

The General Electric company offers, under license from Calentix Technologies, the GE CleanCycle device. It is an organic Rankine cycle that feeds a high-speed turbine-generator assembly housed inside a sealed container without mechanical seals and free of lubrication. In this case, the electric generator is of radial type. The rotating assembly is supported by active magnetic bearings which, unlike a totally passive system, requires a complex control electronics and a constant power supply. In case of a total power cut, an active magnetic bearing can expose the shaft to direct mechanical contact with the stator causing great damage.

Capstone Turbine Corporation develops compact Bryton turbo-generators wherein the turbine-compressor-generator assembly is supported by passive air bearings. In this case, the electric generator is of radial type and the air bearings are based on a rheological phenomenon dependent on the properties of the gas (typically air) and subject to mechanical wear during start-up and shutdown. In addition, the internal combustion of the Bryton cycle makes it highly sensitive to the type and quality of fuel.

### SUMMARY OF THE INVENTION

The present invention is a compact heat and power generation device, which uses fuels of various types (gaseous or liquid hydrocarbons, biofuels, solid organic matter, etc.) as an energy source. Said device allows to deliver electrical power to an isolated or interconnected low voltage network while delivering heat to an external cooling fluid that can be used as heating or heat source for other processes.

The invention is based on the use of new and industrially scarcely known technologies such as: axial flow and low hysteresis generators; passive magnetic bearings; and passive electrodynamic bearings.

In turn, the invention is a member of a group of existing and widely disseminated technologies such as: gas, diesel, pellet burners; shell and tube heat exchangers, plate heat exchangers, concentric tubes heat exchangers; radial and axial microturbines; centrifugal and positive displacement pumps; power electronics and microcontrollers.

The use of microturbines, electric generators that have low hysteresis and passive magnetic bearings confer to this invention superior operating characteristics compared to the current state of the art, in terms of high operational reliability and minimum maintenance requirements.

The use of external fuel burners and heat exchangers confer to this invention a versatility superior to the current state of the art, in terms of types and qualities of admissible fuels.

### BRIEF DESCRIPTION OF THE FIGURES

FIG. 1 is a schematic view of an embodiment of the invention, wherein fuel is used as an energy source.

FIG. 2 is a schematic view of an alternative embodiment of the invention, wherein waste heat from another process is used.

FIG. 3 is a sectional view of the rotating system.

FIG. 4 is a schematic section of the axial flow generator.

FIG. 5 is a schematic section of one end of the shaft 17.

FIG. 6 shows three views of a compact heat and power generation device and its dimensions are compared taking as a reference the silhouette of an average human adult.

### DETAILED DESCRIPTION OF THE INVENTION

The present invention is a compact heat and power generation device, which uses fuels of various types (gaseous or liquid hydrocarbons, biofuels, solid organic matter, etc.) as an energy source. The device is also capable of using waste heat from another independent process as an energy source to generate electricity.

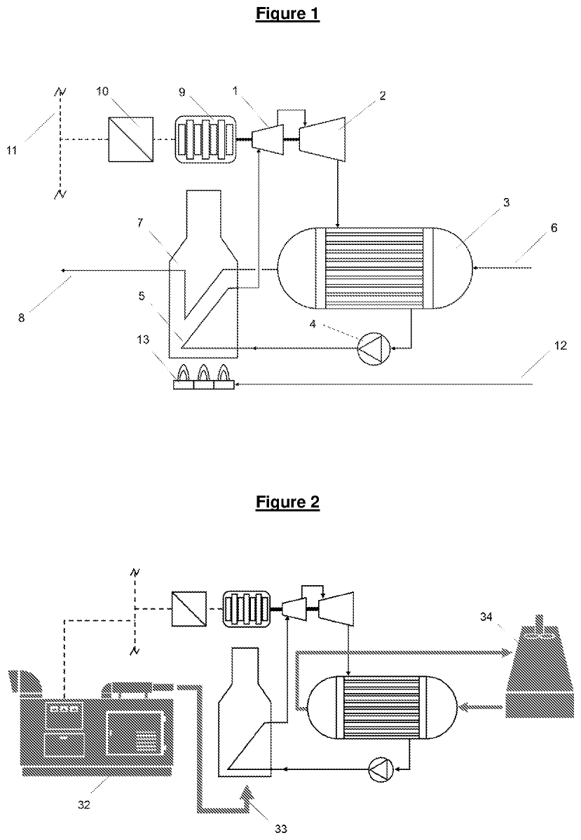

FIG. 1 shows a fuel burner 13, a high-pressure turbine 01, a low-pressure turbine 02 and a heat recuperator for the cooling fluid 07.

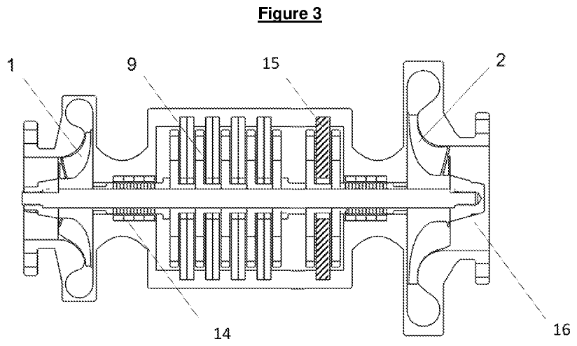

A hydraulic pump 04 pumps an internal working fluid under a high-pressure liquid state (for example, water or some organic fluid) to one side of a heat exchanger 05. On the other side of the heat exchanger 05 a mixture of hot gases circulates from the burning of some gaseous, liquid or solid fuel 12 in a burner suitable for its type 13. FIG. 2 shows a variant of this scheme, wherein hot waste gases of another machine or independent process 32 are conducted appropriately 33 to the heat exchanger 05. In this scheme, own fuel is not burned.

FIG. 3 shows the rotating system comprising two turbines 01 and 02, the power generator 09, the passive magnetic bearings 14, an electrodynamic bearing 15 and the complete turbo-group pressure containment 16.

The working fluid is heated in the heat exchanger 05 and undergoes a phase change until it becomes a dry or slightly humid steam and is conducted to a turbine 01 in which it delivers mechanical power at the expense of lowering its pressure and temperature. In an alternative of the invention, the working fluid is conducted to a second turbine 02 wherein it undergoes a second expansion and cooling delivering more mechanical power.

The working fluid at low pressure enters one of side of a heat exchanger 03 wherein it cools down to undergo a total condensation and then is directed back to the hydraulic pump 04, always remaining within a closed circuit and hydraulically isolated from the rest of the system and the environment.

A cooling fluid 06 circulates through the other side of the heat exchanger 03 and absorbs the heat delivered by the working fluid of the device. This coolant, which has no direct contact with the working fluid, passes through a heat exchanger 07 to absorb the waste heat from the combustion gases of the burner 13 or the hot gases from an external process and thus increase its temperature and the overall efficiency of the device. This cooling fluid of higher temperature 08 allows excess heat to be transported to be used in heating buildings or as a heat source for various industrial processes. In an alternative of the invention the coolant does not pass through the heat exchanger 07 and is conducted directly to a cooling tower.

Turbines 01 and 02 rotate in solidarity with a shaft which also contains the rotor of a permanent magnet and axial flow electric generator 09. Said turbo-group rotates at a high and variable speed and allows the generator to deliver electrical power in the form of high frequency alternating current. An electronic device 10 adapts the electrical power delivered by the generator and injects it into a low voltage electrical network (for example, 380V) to which various loads can be connected. The low voltage network may or may not be connected to a larger electricity distribution network.

The turbo-group is supported and centered radially by radial passive magnetic bearings 14. Said turbo-group can be oriented vertically or horizontally and maintains its axial position by means of one or more passive electrodynamic bearings 15 operating above a certain speed of rotation. While it is rotating at high speed, the turbo-group stays free from mechanical contact with the rest of the device, supported and stabilized only by passive electromagnetic forces.

The turbo-group, the coils of the electric generator, the passive magnetic bearings 14, the electrodynamic bearing 15 and other support systems for the start are completely housed inside a sealed container 16 that keeps the working fluid within the previously mentioned closed circuit.

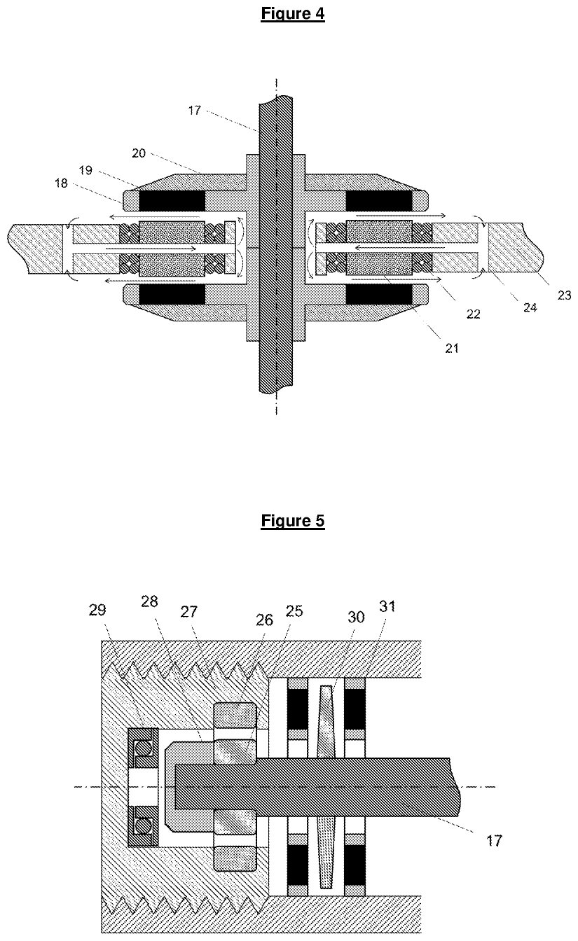

FIG. 4 shows the axial flow generator 09 comprising two or more rotor discs 18 connected to the shaft 17 each one containing the permanent magnets 19. Between each pair of discs are located the stators with the winding 22 and the ferromagnetic core 21 with their respective cooling ducts 24. That is, the axial flow electric generator 09 is formed by a rotor assembly and a stator assembly. The rotor assembly is fixed to the shaft of the turbo-group 17 and has an even number of permanent magnets 19 engaged in non-ferromagnetic discs 18 and facing each other in an attraction configuration. The generator may contain two or more discs with magnets. On the outer face of the discs of each end, a disk of ferromagnetic material 20 in solidarity with the rotor closes the magnetic circuit.

The stator assembly houses the conductors 22 that are wound around numerous cores of high electrical resistance ferromagnetic material 21. These cores allow to close the magnetic circuit between each pair of facing magnets. The outer periphery of the conductors is in contact with a thermally conductive material 23 that dissipates the internal heat towards the generator housing. Circulating ducts 24 within the thermal conductor and the ferromagnetic core allow the process gas flow induced by viscous forces between the rotor and the stator. This flow increases the removal and transport of heat in the innermost areas of the stator.

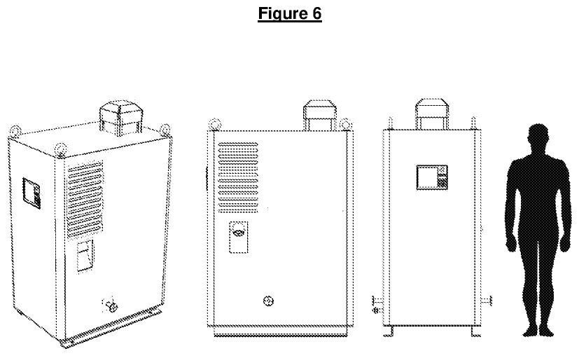

FIG. 5 shows the location of one of the passive magnetic bearings 14 comprised by one mobile magnet 25 and one fixed magnet 26 together with the shaft stop 28 and an auxiliary bearing for start and stop 29. At the same end of the shaft it is shown the electrodynamic bearing 15 formed by a conductor disk 30 in solidarity with the shaft and an assembly of fixed permanent magnets. 31. The turbo-group is supported radially by two passive magnetic bearings 14 near the ends of its shaft 17. Each bearing is formed by one or more pairs of permanent and concentric annular magnets being one mobile 25 and the other fixed 26. The latter is located on an axial register 27 that allows its correct alignment despite the difference in length that may exist between the turbo group and the stator of the assembly. The stabilization of the axial position of the turbo-group is attained by one or more electrodynamic bearings comprising a solid or perforated conductor disk fixed to the shaft 30 and two sets of permanent magnets 31 facing to each other in repulsion configuration supported by fixed discs. This configuration can be reversed, as shown in FIG. 3, where the driver disk is fixed to the housing and the discs supporting the magnets rotate together with the shaft.

The novel technical features of the present device are:

1. It uses as a power plant a turbine driven by a liquid-vapor thermal cycle (Rankine type) and one low hysteresis and axial flow electric generator, mounted on the same shaft. In this way, the electric generator can operate at high speed (high frequency) efficiently.

While Rankine cycle electric power plants have been disclosed, these tend to be large. Some compact generator systems use Rankine cycles, but they usually interpose a speed reduction between the turbine and the generator, which is synchronous with the network.

2. It does not require lubrication in any of its components. The rotating system comprising the turbine and the generator does not require any kind of lubrication since it uses magnetic and electrodynamic bearings, free of mechanical friction. Traditional generators (electric generators, including large power plants) use lubricating oil on all its rotating and rubbing parts. The bearings of this device, driven by passive electromagnetic forces, do not require monitoring and control electronics like the active magnetic bearings either.

3. Sources of heat and cooling are completely external to the thermal cycle. Unlike piston engines or gas turbines (Bryton cycle), this system burns fuel externally, similarly to a boiler. Typically, this method is used in large power plants but not in small equipment.

Regarding the preceding technical features, the following advantages can be noted:

1. Significantly reduces the number of moving parts by not using speed reducers. It does not require mechanical seals as the turbine and the electric generator are contained within the same sealed container and flooded in the working fluid. These characteristics provide an increase in overall system performance.

2. It requires very low maintenance, as it is not necessary to replace lubricant or parts significantly worn by friction. The reliability of the system is high as the passive bearings are simple in design and work even in the case of a total shutdown of the system, until the turbo-group decreases its speed substantially and can rest on the auxiliary start bearings.

3. External combustion eliminates problems of general corrosion and stress corrosion associated with combustion products in internal combustion systems. In this way requirements on the fuel quality (presence of corrosive agents, humidity, etc.) and fuel type are minimized (calorific power, flame speed, etc.). This allows a great flexibility as to the type of fuel to be used, including solid fuels such as biomass. Waste heat from other processes can also be used without the need for additional fuel.

What is claimed is:

1. A compact heat and electricity co-generation device based on the Rankine cycle comprising a power plant formed by one or more radial and/or axial turbines connected to an axial flow electric generator, wherein said turbines and said electric generator are mounted on a same shaft, forming a turbine-generator assembly.

2. The compact heat and power co-generation device according to claim 1, wherein said turbine-generator assembly is radially supported by passive magnetic bearings, comprising one or more concentric mobile ring magnets with one or more fixed ring magnets, mounted near the ends of the shaft.

3. The compact heat and power co-generation device according to claim 2, wherein said passive magnetic bearings have axial registers to absorb the differences in length between the stator and the rotor, ensuring their correct alignment.

4. The compact heat and electricity co-generation device according to claim 2, wherein said turbine-generator assembly is axially supported and stabilized by one or more passive electrodynamic bearings and conventional auxiliary bearings for start and stop.

5. The compact heat and electricity co-generation device according to claim 4, wherein said passive electrodynamic bearings comprise solid or perforated conductive disks and a set of permanent magnets facing in a repulsion configuration.

6. The compact heat and electricity co-generation device according to claim 5, wherein one of said conductive disks and said set of permanent magnets are fixed to a housing and the other of said conductive disks and said set of permanent magnets are connected to the shaft.

7. The compact heat and electricity co-generation device according to claim 1, wherein a fuel comprises a solid, liquid or gaseous fuel.

8. The compact heat and electricity co-generation device according to claim 4, wherein said turbine-generator assembly is housed together with the passive magnetic bearings and the passive electrodynamic bearings inside a sealed container for containing the working fluid pressure and free of mechanical seals.

9. The compact heat and electricity co-generation device according to claim 8, wherein the electric generator comprises internal cooling channels through which the working fluid flows driven by viscous forces between the rotor and the stator.

10. The compact heat and electricity co-generation device according to claim 1, wherein the electric generator has low hysteresis and high electrical resistance ferromagnetic cores.

11. The compact heat and electricity co-generation device according to claim 1, wherein the heat and cooling sources are external to the thermal cycle, so the fuel is externally burned, and the coolant does not contact the working fluid.
